(19) United States
(12) Patent Application Publication
(10) Pub. No.: US 2021/0370352 A1
(43) Pub. Date: Dec. 2, 2021

(54) DETECTING NON-HANDLEABLE ITEMS

(71) Applicant: Siemens Aktiengesellschaft, München (DE)

(72) Inventors: Jörg ROTTLAND, Radolfzell (DE); Eberhard RÖHM, Singen (DE); Michael ZETTLER, Allensbach (DE)

(21) Appl. No.: 16/971,808

(22) PCT Filed: Jan. 8, 2019
(86) PCT No.: PCT/EP2019/050293

§ 371 Date: Aug. 21, 2020

(30) Foreign Application Priority Data
Feb. 21, 2018 (EP) 18157870.9

(51) Int. Cl. B07C 1/00; G01B 11/24; B07C 5/10; B65G 43/00; G06N 3/08

(52) U.S. Cl. CPC B07C 1/00; G01B 11/24; B07C 5/10; B65G 43/00; B65G 2201/0285; B65G 2203/0208; B65G 2203/044; B65G 2201/0264; G06N 3/08

(57) ABSTRACT

A method and a system for detecting consignments or items which cannot be conveyed by a conveying system cost-effectively detect non-conveyable items for a materials handling system. A conveyor section and a light grid or curtain or comparable measuring assembly are configured and disposed in such a way that a consignment or item can be conveyed on the conveyor section through the light grid or curtain, so that a data structure characterizing the consignment or item can be generated by the light grid or curtain and fed into the detection system. The detection system is adapted to judge whether the consignment or item is conveyable or not based on the data structure.

The invention relates to the technical field of the detection of consignments which cannot be conveyed by a conveying system.

Conveying systems may be sorting systems or other kinds of conveying systems, for example for transporting or for sorting baggage within airports. The term conveying system therefore comprises pure conveying systems of consignments, but also sorting systems. Consignments may include baggage of passengers, for example, but also mail consignments, for example letters, packages, mailbags or other kinds of conveyed objects.

The availability of a conveying system falls when non-conveyable consignments are situated on the conveyor section, for example on conveyor belts. Conveyor belts or sorters may break down or be damaged as a result.

Today, the detection of non-conveyable consignments takes place using high-resolution cameras. These generally also involve complex time of flight (ToF) measurements. The technology for this is complex and therefore expensive.

The object underlying the present invention is therefore to detect non-conveyable consignments for a conveying system in a cost-effective manner.

This object is achieved by the methods and apparatuses proposed in the independent claims.

According to one aspect, a method is presented for detecting consignments which cannot be conveyed by a conveying system. The method comprises the following method steps: A consignment is conveyed on a conveyor section by way of a light grid. In doing so, a data structure characterizing the consignment is generated by means of the light grid. The data structure is analyzed by means of a detection system. In the process, it is assessed whether or not the consignment is conveyable.

According to a further aspect, a system is presented for detecting consignments which cannot be conveyed by a conveying system. Said system comprises a conveyor section, a light grid and a detection system. The conveyor section and the light grid are embodied and arranged such that the consignment can be conveyed through the light grid on the conveyor section. In this context, a data structure characterizing the consignment can be generated by means of the light grid and can be fed into the detection system.

The detection system is embodied to assess, on the basis of the data structure, whether or not the consignment is conveyable.

According to a further aspect, a system is presented for detecting consignments which cannot be conveyed by a conveying system. Said system comprises a conveyor section, a measuring array and a detection system. The measuring arrangement comprises a transmitter array and a receiver array, which are embodied and arranged in such a way that between the transmitter array and the receiver array there is a measuring region, which is arranged such that the consignment can be conveyed through the measuring region by means of the conveyor section. The measuring region consists of wave signals which can be emitted by the transmitter array and can be received by the receiver array. The receiver array is embodied to generate receiver signals on the basis of received wave signals and to feed said receiver signals into the detection system. The detection system is embodied to assess, on the basis of receiver signals influenced by the measuring region while the consignment is being conveyed through, whether or not the consignment is conveyable.

Advantageous embodiments of the invention are specified in further claims.

According to one exemplary embodiment, the conveying system is a flight baggage conveying system, according to another exemplary embodiment, a conveying system for sorting shipping packages, according to another exemplary embodiment, a conveying system for sorting letters.

The measuring array may be a light grid, for example, wherein the term light grid is to be understood such that said light grid is not limited to visible light, but rather includes all suitable transmitter-receiver arrays based on electromagnetic waves, in particular also those based on infrared light, visible light, microwaves, ultraviolet light or X-ray radiation. By using a light grid based on visible light or on infrared light, particularly cost-effective solutions are to be expected. According to one embodiment, the transmitters are light-emitting diodes. In addition to light grids, measuring arrays based on non-electromagnetic waves are also conceivable, for example measuring arrays based on acoustic waves.

According to one exemplary embodiment, the data structure generated by means of the measuring array, or generated by means of the light grid, respectively, comprises at least one silhouette, preferably at least two silhouettes of the consignment recorded from different directions. Silhouettes have the advantage that they can be generated by means of a light grid in a particularly simple manner. In addition, silhouettes have the advantage, particularly compared to photographic solutions, that they can detect and evaluate the consignments particularly easily.

According to one exemplary embodiment, the data structure generated by means of the measuring array, or generated by means of the light grid, respectively, comprises two silhouettes, wherein a first silhouette is a vertical silhouette and a second silhouette is a horizontal silhouette of the consignment. According to one exemplary embodiment, the two silhouettes are perpendicular to the conveying direction of the conveyor section. The vertical silhouette can be generated by a light grid, which a transmitter array or a receiver array has arranged in a gap interrupting the conveyor section.

According to one exemplary embodiment, the silhouette is designed as a binary image, or the silhouettes are designed as binary images, respectively.

According to one exemplary embodiment, the detection system learns the assessment of whether or not the consignment is conveyable automatically, preferably by means of a neural network, preferably by means of a computer-implemented neural network.

According to one exemplary embodiment, a suitable measure is performed, should the result of the assessment be that the consignment is not conveyable. A suitable measure may be, for example, the outward transfer of the consignment out of the conveying system, but also the moving or shifting of the consignment into a conveyable state, for example by retracting an extended handle of a wheeled suitcase into the wheeled suitcase, for a flight baggage conveying system. In order to perform a suitable measure, the system for detecting consignments which cannot be conveyed by a conveying system may comprise a correction system which can be actuated by the detection system. The correction system may be a diverter, for example, for the outward transfer of a non-conveyable consignment out of the conveying system. Other correction systems may be embodied, for example, in order to move the non-conveyable consignment or shift it into a conveyable state.

According to an exemplary embodiment, the measuring region is arranged such that it is flat and transverse to the conveying direction of the conveyor section, preferably perpendicularly. This can be achieved in a particularly simple manner using a light grid and results in the advantage that the consignment can be scanned while it is being conveyed through the flat measuring region. In other words, this means that the measuring region may be smaller in the conveying direction than the consignment.

According to one exemplary embodiment, the transmitter array comprises one or more transmitters and/or the receiver array comprises one or more receivers.

According to one exemplary embodiment, the transmitter array and the receiver array are arranged opposite one another, as is generally the case in commercially available light grids for example. This enables particularly simple constructions. However, other solutions, in which transmitter and receiver of a light grid are arranged nested inside one another in a row, are likewise conceivable.

According to an exemplary embodiment, the transmitter array comprises a directional characteristic, wherein the directional characteristic of a transmitter, i.e. a strong intensity, is preferably directed toward a receiver. In alternative exemplary embodiments, the directional characteristics do not have to be directed toward the receivers, and it is not even necessary for each transmitter to be assigned precisely one receiver. Solutions are likewise conceivable, in which more complex measuring arrays are trained by means of neural networks to assess whether or not a consignment is conveyable.

The invention is explained in greater detail below on the basis of the figures for example, in which:

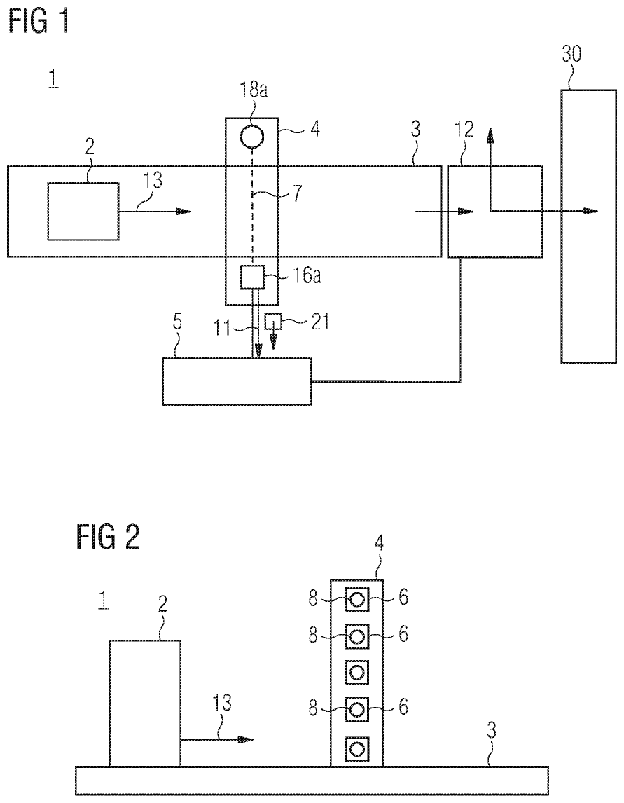

FIG. 1 shows a schematic representation from above of a system for detecting consignments which cannot be conveyed by a conveying system, according to one exemplary embodiment of the invention;

FIG. 2 shows a schematic representation from the side of the system shown in FIG. 1;

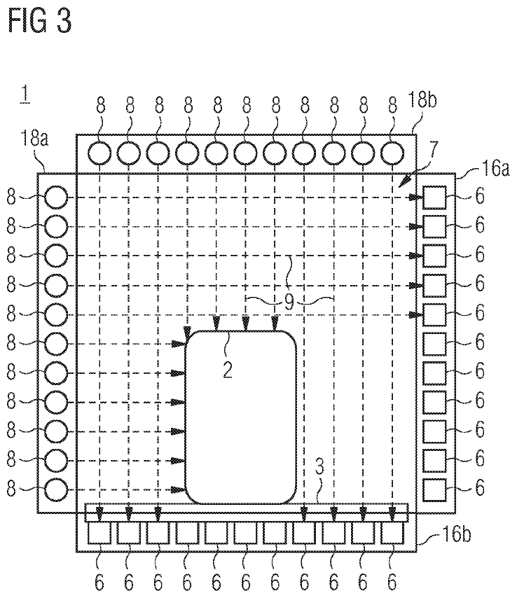

FIG. 3 shows a schematic representation from another side of the system shown in FIGS. 1 and 2;

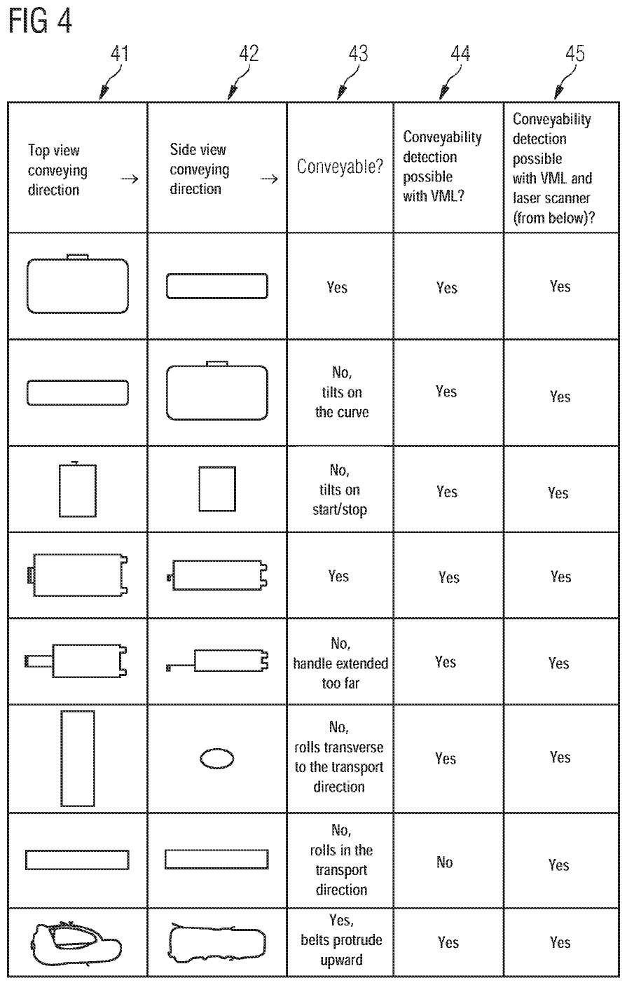

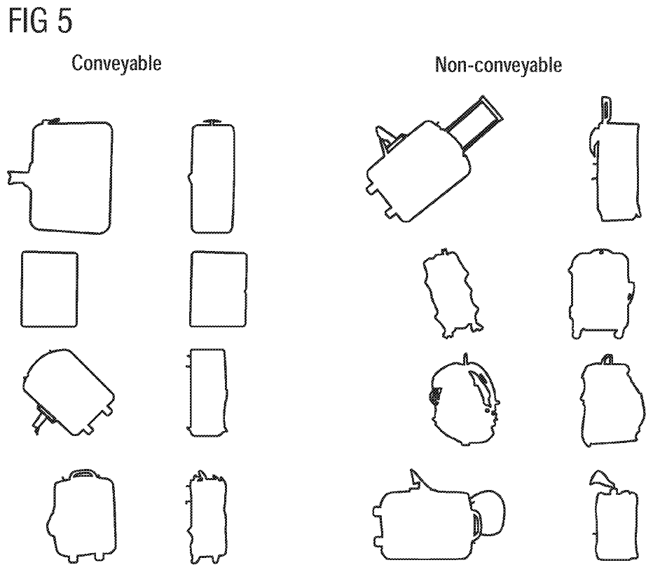

FIG. 4 shows a plurality of silhouettes of baggage items of a flight baggage conveying system together with an assessment of whether or not said baggage items can be conveyed on the flight baggage conveying system;

FIG. 5 shows further pairs of silhouettes, divided into conveyable and non-conveyable consignments.

FIG. 1 shows a schematic representation from above of a system 1 for detecting consignments 2 which cannot be conveyed by a flight baggage conveying system 30, according to one exemplary embodiment of the invention. In the following, the system 1 is also termed classification system 1.

The classification system 1 comprises a conveyor section 3, a measuring array 4 comprising a light grid and a detection system 5.

The conveyor section 3 is embodied to convey the consignment 2 along a conveying direction 13. The conveyor section 3 and the measuring array 4 are embodied and arranged such that the consignment 2 can be conveyed through a measuring region 7 of the measuring array 4 on the conveyor section 3, in such a way that in the process a digital data structure 21 characterizing the consignment can be generated by means of the measuring array 4 and can be fed into the detection system 5. For this purpose, the light grid is arranged transversely, preferably orthogonally to the conveying direction 13. This means that the data structure 21 can be generated by means of a scanning procedure while the consignment 2 is being conveyed through the light grid. The detection system 5 is adapted to assess, on the basis of the data structure 21, whether or not the consignment 2 is conveyable. Likewise evident in FIG. 1 is a transmitter array 18a with light-emitting diodes 8 arranged vertically in a line and a receiver array 16a with photodiodes 6 arranged vertically in a line.

FIG. 2 shows the classification system 1 from Figure from the side, with a viewing direction perpendicular to the conveying direction 13, with the light-emitting diodes 8 of the transmitter array 18a arranged vertically in a line and the photodiodes 6 of the receiver array 16a arranged vertically in a line.

FIG. 3 shows a schematic side representation of the classification system 1 from FIG. 1 along the conveying direction 13. In this view, the measuring array 4 can be identified particularly clearly. The measuring array 4 comprises two light grids, wherein one of the light grids is arranged horizontally and the other light grid is arranged vertically. Each of the light grids comprises a transmitter array 18a and a receiver array 16a, or 18b and 16b, respectively. Each of the transmitter arrays 18a, 18b comprises linearly arranged light-emitting diodes 8 and each of the receiver arrays 16a, 16b comprises linearly arranged photodiodes 6.

In the vertically arranged light grid (vertical with regard to the direction of the beam path), the light-emitting diodes 8 of the transmitter array 18b are arranged above the photodiodes 6 of the receiver array 16b. Each of the light-emitting diodes possesses a directional characteristic, i.e. a direction in which the light-emitting diode 8 radiates a maximum intensity, and which is directed toward a photodiode 6 of the receiver array 16b lying therebelow. This defines a vertical grid, which is characterized by vertically extending wave signals 9, similar to vertically extending grid bars. In order to attach the receiver array 16b embodied in a bar-like manner as easily as possible, the conveyor section 3 comprises an interruption, or a gap which preferably extends perpendicularly to the conveying direction 13, respectively, in which the receiver array 16b is embedded.

In this manner, between transmitter array 18b and the receiver array 16b, wave signals 9 which can be transmitted by the transmitter array 18a and can be received by the receiver array 16a define a measuring region 7, which is arranged such that the consignment can be conveyed through the measuring region 7, or through the light grid 4, respectively, by means of the conveyor section 3.

In a similar manner, the measuring array 4, as shown in FIG. 3, comprises a horizontal light grid, which comprises the transmitter array 18a and the receiver array 16a, by means of which horizontal wave signals 9 define the measuring region 7. In the exemplary embodiment shown in FIGS. 1-3, the horizontal light grid 16a, 18a has the same measuring region 7 as the vertical light grid 16b, 18b. In other exemplary embodiments, the measuring regions of the two light grids are different, for example in that the light grids are not arranged in the same plane, or are arranged in the same plane, but offset from one another. Embodiments are also conceivable, in which only one light grid is used. For example, in the case of suitcases lying horizontally, it should already be able to be detected by means of a silhouette generated by a vertical light grid whether a handle of the suitcase is situated in an extended state.

At this point, it should also be mentioned that the term “light grid” includes a horizontal light grid, a vertical light grid and an otherwise suitably arranged, e.g. obliquely arranged light grid. The term “light grid” also includes arrays consisting of two or more light grids, for example as in the double light grid with the horizontal and vertical light grid shown in FIG. 3.

For example, an MLG2 light array by the company Sick may be used as the light array 4.

The receiver arrays 16a, 16b, or the photodiodes 6, respectively, are embodied to generate electronic receiver signals 11 on the basis of received wave signals 9, and to feed these into the detection system 5. The detection system 5 is embodied to assess, on the basis of receiver signals 11 influenced by the measuring region 7 while the consignment 2 is being conveyed through, whether or not the consignment 2 is conveyable.

To this end, the detection system may receive electronic receiver signals 11, or data structures 21 contained in the receiver signals 11, respectively, from the horizontal light grids 16a, 18a shown in FIG. 3 for example and from the vertical light grids 16b, 18b, which data structures 21 in each case represent a silhouette, or comprise one, respectively, i.e. a silhouette projected onto the base plane from the vertical light grid, as well as a silhouette projected onto a vertical side plane, extending in parallel with the conveying direction 13, from the horizontal light grid. These silhouettes can be represented by the detection system 5 as binary images, and can be further processed by their contours or outer limits or other characteristics being ascertained, which are suitable for assessing whether or not the consignment can be conveyed through the conveying system.

The light-emitting diodes 8 and the photodiodes 6 preferably operate in the infrared range or with visible light. In alternative embodiments, other suitable ranges of the electromagnetic spectrum may also be used. Solutions are likewise conceivable in which acoustic transmitters and receivers are used instead of photodiodes and photodetectors.

In variant exemplary embodiments, the light-emitting diodes or other kinds of transmitters of the transmitter array do not have to be directed toward photodiodes or other kinds of receivers in a manner similar to a grid, i.e. with wave signals extending in parallel. For example, the signals may also extend in crossed or skewed paths. It should be expected that, by means of neural networks, such measuring arrays can even be trained in order to be able to make statements about the conveyability of a consignment. Solutions are also conceivable, in which the directional characteristics, or the maxima thereof, do not have to be directed toward the receivers, but also solutions with transmitter arrays which have no directional characteristics at all, for example in that neural networks are trained with the output signals of the receiver array, i.e. the receiver signals, to assess whether or not the consignment is conveyable.

With reference to FIG. 1, the classification system 1 additionally comprises a diverter 12 which can be actuated by the detection system 5 and which outwardly transfers the consignment 2, should the result of the assessment be that the consignment 2 is not conveyable. Alternatively or additionally, a warning means may also generate a signal which can be perceived by humans and which indicates to the operating personnel that a measure has to be taken. Should the result of the assessment be that the consignment 2 is conveyable, then the consignment is conveyed on the conveying system 30.

Using the exemplary embodiments described in the figures, and variants thereof, methods for detecting consignments which cannot be conveyed by a conveying system can be performed. In this context, the consignment 2 is conveyed through the light grid 4 on the conveyor section 3 and, in doing so, a digital data structure 21 characterizing the consignment 2 is generated by means of the light grid 4. The data structure 21 is analyzed means of the detection system 5. The analysis includes an assessment of whether or not the consignment 2 is conveyable.

The data structure 21 generated by means of the light grid 4 comprises at least one silhouette, preferably at least two silhouettes of the consignment recorded from different directions. The silhouettes are binary images and can be recorded perpendicularly to the conveying direction 13 of the conveyor section 3 as well as perpendicularly to one another in a horizontal and a vertical projection direction.

The detection system 5 learns the assessment of whether or not the consignment is conveyable automatically, preferably by means of a neural network, preferably by means of a computer-implemented neural network. In an alternative embodiment, the detection system 5 uses algorithms to assess whether or not the consignment 2 can be conveyed.

Conveyable consignments are conveyed further on the conveying system. For non-conveyable consignments, a suitable measure is taken, for example outwardly transferring the baggage item out of the conveying system 30, or not inwardly transferring the baggage item into the conveying system 30, respectively, and/or generating a warning signal for manual processing and/or shifting the consignment into a conveyable state.

FIG. 4 shows, by way of example, in table format, silhouettes of baggage items in a top view 41 and in a side view 52 in the first two columns. The third column 43 contains an assessment (yes/no) of whether or not the baggage item is conveyable. In the fourth column 44, it is captured whether it is possible to use a light grid to assess whether or not the baggage item is conveyable. In addition, in the fifth column 45 it is captured whether a light grid and a laser scanner, which acts from below, can be used to assess whether or not the baggage item is conveyable.

A further exemplary embodiment comprises the following:

1. Integrating a 2D light grid into the conveying technology and generating a pair of binary images.

2. Binary images are transferred to a detection system. Situated there is a detection system based on Deep Learning for example, which has been trained on test material in advance. It classifies the image data into “conveyable” and “non-conveyable” objects.

3. In the case of “non-conveyable”, an action is triggered. Either the belt is stopped or the baggage item is moved out of the system.

4. Optionally: Provided that no prior-trained network is available, the image data is transmitted to a video encoding system (VCS). An operator receives the representation of the object presented on the monitor and he classifies the object into conveyable or non-conveyable online.

A network is cyclically trained on the basis of the images and the associated results of the operator.

This is repeated until a certain detection level is achieved.

5. Optionally: The image data and the results of the VCS are sent to a cloud. There, the network is calculated with the use of a GPU and is transmitted to the station.

Exemplary embodiments of the invention enable a detection of non-conveyable consignments on the basis of images from cost-effective sensors such as light grids and deep neural networks for object classification.

According to further exemplary embodiments, an image processing computer without GPU acceleration is used. There, there is the risk of too high a number of false positives or undetected non-conveyable consignments. As a measure, an additional laser scanner may also be used as a second data source.

Exemplary embodiments of the invention may also have the following advantages:

1. A light source is very cost-effective.

2. A pseudo-binary image can be generated and a Deep Learning network can be trained on the basis of a test set.

3. A video encoding system can be used in order to classify the objects and the Deep Learning network is calculated or trained on this basis.

5. The network is used for classification into conveyable and non-conveyable consignments. 6. An additional image camera can also be used in order to record images of the consignment, in order to obtain an improved understanding of other data.

It is also possible to assess whether or not the consignment is conveyable for dark and shiny consignments.

1-17. (canceled)

18. A method for detecting consignments, including flight baggage, packages and letters, which cannot be conveyed by a conveying system, the method comprising:
conveying a consignment on a conveyor section through a light grid and generating a data structure characterizing the consignment by using the light grid; and
analyzing the data structure by using a detection system to provide an analysis including an assessment of whether or not the consignment is conveyable.

19. The method according to claim 18, wherein the data structure generated by the light grid includes at least one or at least two silhouettes of the consignment recorded from different directions.

20. The method according to claim 18, which further comprises operating the light grid with at least one of infrared light or visible light.

21. The method according to claim 18, which further comprises using the detection system to automatically learn the assessment of whether or not the consignment is conveyable.

22. The method according to claim 21, wherein the detection system uses a neural network or a computer-implemented neural network to automatically learn the assessment of whether or not the consignment is conveyable.

23. The method according to claim 18, which further comprises performing an outward transfer, moving or shifting of the consignment into a conveyable state upon a result of the assessment that the consignment is not conveyable.

24. A system for detecting consignments which cannot be conveyed by a conveying system, the system comprising:
a conveyor section, a light grid and a detection system;
said conveyor section and said light grid being configured and disposed to permit the consignment to be conveyed through said light grid on said conveyor section, to use said light grid to generate a data structure characterizing the consignment and to feed said data structure into said detection system; and
said detection system being adapted to assess whether or not the consignment is conveyable, based on said data structure.

25. The system according to claim 24, wherein said data structure includes at least one silhouette or at least two silhouettes of the consignment recorded from different directions.

26. The system according to claim 24, wherein said light grid is an infrared light grid or a light grid operating in the visible range.

27. A system for detecting consignments which cannot be conveyed by a conveying system, the system comprising:
a conveyor section, a measuring array and a detection system;
said measuring array including a transmitter array and a receiver array being configured and disposed to transmit wave signals from said transmitter array to said receiver array and to define a measuring region between said transmitter array and said receiver array;
said conveyor section conveying the consignment through said measuring region;
said receiver array being configured to generate receiver signals based on receiving said wave signals and to feed said receiver signals into said detection system; and
said detection system being configured to assess whether or not the consignment is conveyable, based on said receiver signals influenced by said measuring region during a conveyance of the consignment through said measuring region.

28. The system according to claim 27, wherein said measuring region is flat and transverse to a conveying direction of said conveyor section.

29. The system according to claim 27, wherein said transmitter array and said receiver array are disposed opposite one another.

30. The system according to claim 27, wherein said transmitter array includes one or more transmitters and said receiver array includes one or more receivers.

31. The system according to claim 30, wherein said transmitter array includes a directional characteristic.

32. The system according to claim 31, wherein said directional characteristic is a directional characteristic of a transmitter directed toward a receiver.

33. The system according to claim 27, wherein said transmitter array includes light sources or light-emitting diodes generating said wave signals.

34. The system according to claim 33, wherein said wave signals are at least one of infrared signals or light signals.

35. The system according to claim 27, wherein said detection system is configured to automatically learn an assessment of whether or not the consignment is conveyable.

36. The system according to claim 35, wherein said detection system includes a neural network or a computer-implemented neural network to automatically learn an assessment of whether or not the consignment is conveyable.

37. The system according to claim 27, which further comprises a correction system or diverter to be actuated by said detection system to perform an outward transfer, moving or shifting of the consignment into a conveyable state, upon a result of an assessment that the consignment is not conveyable.

38. The system according to claim 27, wherein the system for detecting consignments which cannot be conveyed by a conveying system is a flight baggage conveying system or a conveying system for sorting packages or a conveying system for sorting letters.
